(19) United States
(12) Patent Application Publication
(10) Pub. No.: US 2024/0335956 A1
(43) Pub. Date: Oct. 10, 2024

(54) MAGNETIC JAMMING MECHANISM

(71) Applicant: KOREA INSTITUTE OF SCIENCE AND TECHNOLOGY, Seoul (KR)

(72) Inventors: Donghyun HWANG, Seoul (KR); Changseob SONG, Seoul (KR)

(73) Assignee: KOREA INSTITUTE OF SCIENCE AND TECHNOLOGY, Seoul (KR)

(21) Appl. No.: 18/423,759

(22) Filed: Jan. 26, 2024

(30) Foreign Application Priority Data
Apr. 7, 2023 (KR) 10-2023-0046420

(51) Int. Cl. B25J 15/06; B25J 13/08

(52) U.S. Cl. CPC B25J 15/0608; B25J 13/085; B25J 13/087

(57) ABSTRACT

The present disclosure relates to a magnetic field-based jamming mechanism with variable stiffness and shape adaptation functionalities that can adapt to various characteristics (shape, softness, etc.) of the external environment, and can easily grip objects having various shapes since it grips objects using changes in the stiffness of soft magnetic particles.

### CROSS-REFERENCE TO RELATED APPLICATIONS

This application claims the benefit under 35 USC 119 (a) of Korea Patent Application No. 10-2023-0046420 filed on Apr. 7, 2023, in the Korean Intellectual Property Office, the entire disclosure of which is incorporated herein by reference for all purposes.

### BACKGROUND OF THE INVENTION

### Field of the Invention

The present disclosure relates to a magnetic field-based jamming mechanism with variable stiffness and shape adaptation functions that can adapt to various characteristics (shape, softness, etc.) of the external environment.

### Description of the Related Art

Robot technology that can be used in daily life has been developed in various forms such as grippers and manipulators to perform specific movements repeatedly, quickly, and accurately. In particular, in order for robots to perform high-repetition, high-precision, and high-load tasks, the manipulator is the most important robot system for practical task performance.

Depending on the type of work and the size of the work environment, manipulators have been developed in various forms such as SCARA robots, Stuart platforms, and multi-degree-of-freedom robot arms, and are mainly driven by rigid actuators such as electric motors and hydraulic cylinders. It is made of rigid material and is suitable for performing high-repetition, high-precision, high-load work using high output of electric motors and hydraulics, and is utilized in various industrial fields. However, there were limitations that could be a significant risk in the event of a collision or malfunction in using in daily life where there is a lot of interaction with people, and that the working environment was limited.

For robust movement, manipulators with low mechanical flexibility but high precision, high repetition, and high load movement have been developed, but there are problems such as risk and insufficient work radius, and to solve this problem, robot arms that increase mechanical flexibility and mimic the human body, and redundant manipulators have been developed. In addition, various adaptive control theories have been developed to solve insufficient mechanical structural flexibility and to ensure safe interaction.

To solve the problems of existing stiffness material-based manipulators, robot researchers have conducted various studies, such as research on the driving mechanism of the manipulator itself and research on control algorithms for safe driving. In the case of existing rigid manipulators, there was a problem with high inertia because each joint had a motor, research was conducted to lower the moment of inertia of the manipulator itself by moving the driving motor to the outside of the robot arm using a cable structure and spring-based gravity compensation mechanism, researches have been developed to apply impedance control algorithms based on time delay control to control contact force between robots and people, in addition, various AI-based control technologies have been developed to detect safety.

However, in an effort to solve the fundamental problems of these rigid manipulators, soft actuators based on flexible materials have been developed in various forms and have been applied as manipulators. Typically, as soft robot research becomes more active, it can be explained that it has developed into a manipulator that has high adaptability and complex movements using the high multi-degree-of-freedom characteristics of soft materials in existing non-redundant and redundant manipulators.

In response to efforts to apply soft actuator-based manipulators to human daily life, efforts have been made to imitate the driving mechanisms of various animals and plants existing in the natural world, and various soft manipulators have begun to be developed.

Many robot researchers have been inspired by the shapes of octopuses and elephant trunks, which have high adaptability to the natural environment, and applied them to the development of soft manipulators. In particular, octopuses with high adaptability have been a subject of great interest to robot researchers studying soft manipulators.

General soft manipulators have been developed in the form of a continuum robot in which soft actuators made of soft materials are arranged in circular symmetry. Soft actuators have been implemented by various actuation mechanisms such as electroactive polymers (EAPs), shape memory alloys (SMAs), pneumatic actuators, and actuators using cables and motors. However, the actuation mechanisms by SMAs and EAPs have been difficult to implement sufficient force to perform practical robotic tasks, and general soft grippers have mainly been driven by cables and motors or driven by pneumatics.

Continuum robots, which have been studied since the 1960s, are mainly driven by cables and motors, and are types that can transmit force by cable router, perform a variety of movements, adapting to the external environment, being composed of a rigid backbone capable of implementing movement in the form of a continuum, performing robotic tasks.

In order to imitate the movements of living organisms such as elephant trunks and octopus legs to adapt to the external environment in an unstructured environment and realize desired movements and successful robot tasks, shapes with various diameters ranging from a few millimeters to tens of centimeters have been developed. To implement bending movements by cables, a backbone based on a stiffness material is essential, but when performing work in an unstructured environment, there is a problem that unwanted collisions can occur, which can cause safety issues in the interacting external environment.

Soft manipulators using pneumatics are inspired by organisms in the natural environment, such as an elephant's trunk and an octopus' leg, and have begun to develop a soft manipulator that replaces the existing rigid structure-based continuum robot by using the high adaptability of soft materials. In particular, it was developed in the form of a continuum robot consisting of three or four soft pneumatic actuators per manipulator module, using compartmentalized deformation.

By applying different pressures to each driving module, omnidirectional bending, linear movement, etc. are implemented. In general, it has been developed as a compartmentalized manipulator module, such as the STIFF-FLOP structure, but manipulators using a honeycomb structure and air-bladder structure have also been developed.

However, due to the nature of soft materials, soft manipulators have problems such as difficulty transmitting force efficiently, sagging due to gravity, and low payload for practical robot work, so there has been a need for research into additional variable stiffness structures to solve these problems.

For safe interaction using soft manipulators, robot technology with high base weight without losing the high adaptability of soft materials is the most important factor to be solved for the popularization of soft robots, and can be an innovative solution to solve the safety problems of existing hard robots.

Variable stiffness structures have been developed mainly to operate by being embedded in robots, and representative driving methods for variable stiffness can be divided into stiffness change using structural interaction, and stiffness change using the electrochemical properties or physical phenomena of the material itself.

The method of using the interaction of mechanical structures uses a mechanism to maintain the stiffness of the entire robot structure in a stable state by using the interaction of mechanical elements, and the jamming method is typically applied.

By controlling the variable stiffness mechanism to maintain a stable state, a continuous rigid state can be implemented and relatively fast driving is possible, so it is applied to many soft robots. The jamming mechanism generally implements a change in stiffness by interlocking the materials present in the pneumatic chamber by negative pressure generated by a pneumatic pump.

This method embeds fine particles inside a balloon-shaped pouch and can stably grip objects with various characteristics (shape, ductility, etc.) depending on turning the pneumatic pressure on and off.

However, since this jamming method uses a pneumatic pump to grip an object, modularization is difficult due to the space and weight the system occupies due to the use of bulky devices such as pumps and regulators, and additionally, due to the nature of the pneumatic driving method, high-speed, high-precision stiffness control is difficult.

### PRIOR TECHNICAL LITERATURE

### Patent Document

(Patent Document 1) PCT Application No. PCT/US2015/014970 (Filing Date: Feb. 9, 2015)

### SUMMARY OF THE INVENTION

The technical problem to be solved by the present disclosure aims to develop a magnetic field-based jamming technology that has high-speed, high-precision variable stiffness and shape adaptation functionalities, simple structure, and allows modularization of the entire system.

Additionally, the present disclosure aims to develop a magnetic field driving-based jamming technology that can be used in various application fields such as a gripper or phalanges of robotic grippers, a variable stiffness robot joint, a terrain-adaptive foot of a walking robot, and a three-dimensional tangible display with a variable shape or stiffness.

In order to solve the above technical problem, a magnetic field jamming mechanism of one embodiment comprises a pouch containing a magnetic material, at least two types of soft magnetic particles of different sizes stored in the pouch, an electromagnet disposed at an entrance of the pouch and arranging magnetically the soft magnetic particles, a sensor disposed between the soft magnetic particles and the electromagnet, and a frame that binds the electromagnet to the entrance of the pouch.

The magnetic material contained in the pouch is iron powder with a purity of 99% or more, the pouch further contains silicone, and a mixing ratio of the iron powder and the silicon is 3:2 based on weight percent.

A thickness of the pouch is 1 mm or more and 2 mm or less.

The soft magnetic particles contain iron powder with a purity of 99% or more and iron granules with a purity of 99% or more, and a mixing ratio of the iron powder and the iron granules is 3:2 wt %.

A size of the iron granules is 1 to 2 mm.

The electromagnet has a hole inside, and in this case, the jamming mechanism of the present disclosure further comprises a mesh filter located between the electromagnet and the sensor and attached to a portion corresponding to the hollow of the electromagnet.

The sensor includes a first sensor that detects stiffness based on a magnetic force between the soft magnetic particles and the electromagnet, and a second sensor that detects an external force applied perpendicularly to a surface of the pouch.

According to the magnetic field jamming mechanism according to an embodiment of the present disclosure, it is possible to easily grip objects of various shapes since the object is gripped using changes in the stiffness of soft magnetic particles, furthermore, it is possible to easily grip soft objects by adjusting the stiffness of the soft magnetic particles to be weak during initial gripping, and in addition, it is possible to stably maintain the state adapted to the external shape that interacts by maintaining the stiffness of the soft magnetic particles to be high after gripping the object.

The magnetic field jamming mechanism of this embodiment has the advantage of being able to be used as a gripping aid by being deployed in plural numbers or used together with a robot hand.

Additionally, the magnetic field jamming mechanism according to an embodiment of the present disclosure can be used in potential application fields such as a gripper's hand, a robot hand's palm, a variable stiffness rotation joint, a variable stiffness three-dimensional haptic display, a high-speed modular continuum robot, and a terrain adaptive foot of a walking robot.

### BRIEF DESCRIPTION OF THE DRAWINGS

The accompanying drawings, which are included to provide a further understanding of the present disclosure and constitute a part of the detailed description, illustrate embodiments of the present disclosure and serve to explain technical features of the present disclosure together with the description.

FIG. 1 is a diagram illustrating a magnetic field jamming mechanism of one embodiment.

FIG. 2 is an exploded view illustrating a magnetic field jamming mechanism shown in FIG. 1.

FIG. 3 is a diagram illustrating a cross-sectional view taken along line A-A′ of FIG. 1.

FIG. 4 is a diagram illustrating arrangement of magnetic domains in soft magnetic particles.

FIG. 5 is a diagram for explaining an operation of a magnetic field jamming mechanism of one embodiment.

FIG. 6 is pictures taken by a magnetic field jamming mechanism implemented according to an embodiment gripping objects of various shapes.

FIG. 7 is a graph illustrating results of measuring changes in stiffness of soft magnetic particles depending on voltage.

FIG. 8 is a graph illustrating results of measuring response time of soft magnetic particles according to magnetic field jamming.

### DETAILED DESCRIPTION OF THE EMBODIMENTS

Hereinafter, embodiments of the present disclosure will be described in detail with reference to the drawings. However, detailed descriptions of known functions or configurations that may obscure the gist of the embodiments are omitted in the following description and attached drawings. In addition, throughout the specification, ‘including’ a certain component does not mean excluding other components unless specifically stated to the contrary, but rather means that other components may be further included.

Additionally, terms such as first, second, etc. may be used to describe various components, but the components should not be limited by the above terms. The above terms may be used for the purpose of distinguishing one component from another component. For example, a first component may be referred to as a second component without departing from the scope of the present disclosure, and similarly, the second component may also be referred to as the first component.

The terms used in the present disclosure are only used to describe specific embodiments and are not intended to limit the present disclosure. Singular expressions include plural expressions unless the context clearly indicates otherwise. In the present disclosure, terms such as “comprise” or “include” are intended to designate the presence of described features, numbers, steps, operations, components, parts, or combinations thereof, and it should be understood that this does not exclude in advance the presence or addition of one or more other features, numbers, steps, operations, components, parts, or combinations thereof.

Unless specifically defined otherwise, all terms used herein, including technical or scientific terms, have the same meaning as generally understood by a person of ordinary skill in the technical field to which the present disclosure pertains. Terms such as those defined in commonly used dictionaries should be interpreted as having a meaning consistent with the meaning in the context of the related technology, and unless clearly defined in the present disclosure, should not be interpreted in an idealized or excessively formal meaning.

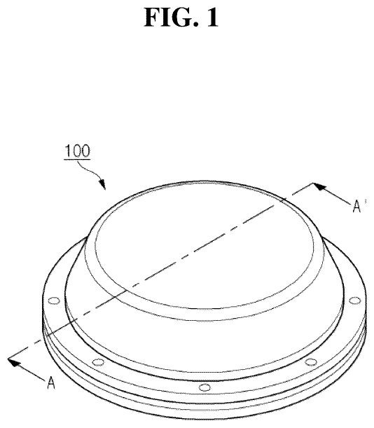

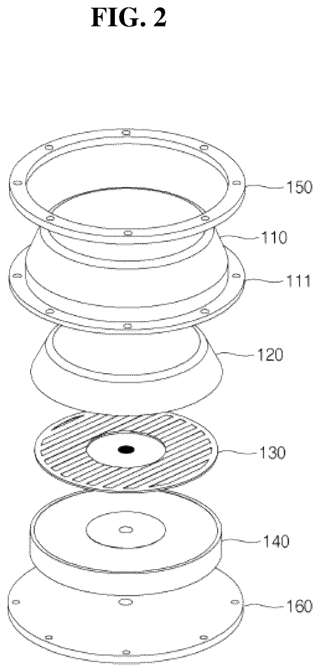

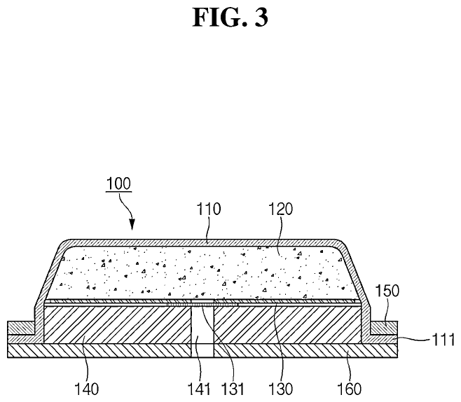

Hereinafter, a magnetic field jamming mechanism 100 of one embodiment will be described with reference to FIGS. 1 to 3. FIG. 1 is a diagram illustrating a magnetic field jamming mechanism of one embodiment, FIG. 2 is an exploded view illustrating a magnetic field jamming mechanism shown in FIG. 1, and FIG. 3 is a diagram illustrating a cross-sectional view taken along line A-A′ of FIG. 1.

Referring to this drawing, the magnetic field jamming device 100 of one embodiment includes a pouch 110 containing a magnetic material and silicon and having an entrance, at least two types of soft magnetic particles 120 of different sizes stored in the pouch, an electromagnet 140 disposed at the entrance of the pouch and arranging magnetically the soft magnetic particles, a sensor 130 disposed between the soft magnetic particles and the electromagnet, and a frame 150 and 160 that binds the electromagnet to the entrance of the pouch.

The soft magnetic particles dispersed in the silicon of the pouch 110 may be iron powder with a purity of 99% or more, and in this case, a mixing ratio of the iron powder and the silicon is 3:2 based on weight percent.

The soft magnetic particles contain iron powder with a purity of 99% or more and iron granules with a purity of 99% or more, a mixing ratio of the iron powder and the iron granules is 3:2 weight % (wt %), and a size of the iron granules is 1 to 2 mm.

The sensor includes a first sensor that detects stiffness based on a magnetic force between the soft magnetic particles and the electromagnet, and a second sensor that detects an external force applied perpendicularly to a surface of the pouch. As an example, the sensor may be a thin-film force sensor with a thickness under 1 mm.

Hereinafter, the above-described configuration will be described in more detail.

The pouch 110 is configured to be deformable by adapting to the three-dimensional shape of the internal soft magnetic particles 120 in response to the magnetic field of the electromagnet 140. In the present disclosure, the pouch 110 is made of a magnetorheological elastomer. If the thickness of the pouch 110 is too thick, the ability to hold an object decreases, and if the thickness of the pouch 110 is too thin, the ability to hold an object improves, but it has the disadvantage of being easily torn. In addition, since the soft magnetic particles stored in the pouch 110 react magnetically and adapt well to the shapes of external environments, the magnetic field jamming mechanism of the present disclosure must set the height of the pouch so that the soft magnetic particles can respond well to the magnetic field and adapt well to the external shape.

As a result of the present inventor's confirmation through various experiments, if the thickness of the pouch is thinner than 1 mm, it is less durable or easily torn, and if it is thicker than 2 mm, the pouch's ability to adapt to the external shape with which it interacts is reduced. Therefore, it is desirable for the pouch to have a thickness greater than 1 mm and less than 2 mm.

In one example, the magnetically responsive pouch 110 can be made by mixing silicone elastomer, for example, brand name Ecoflex00-20, with soft magnetic granules, for example −20 mesh, 99.9% purity iron powder.

When soft magnetic particles are included in the pouch 110, since the magnetic reactivity with the soft magnetic particles 120 stored in the pouch 110 improves, jamming mechanisms can not only improve the ability to transmit force to the external environment, such as the grip force to hold an object, but also improve response performance measured when a signal is applied to the jamming device 100.

The above-described pouch 110 can be made through various known methods. For example, it can be made by mixing silicone and soft magnetic granules, pouring them into a mold, and then hardening them.

The pouch 110 has a ladder cross-sectional shape with an empty interior, and includes a protrusion 111 on the entrance side where the frames 150 and 160 are located. The frames 150 and 160 are coupled with the protrusion 111 therebetween to fix the parts constituting the jamming device 100.

Hereinafter, the soft magnetic particles 120 will be described.

The soft magnetic particles 120 use soft magnetic materials to implement variable stiffness characteristics. In one example, the soft magnetic particles 120 use pure iron (purity of 99% or more) with excellent magnetic properties (magnetic permeability).

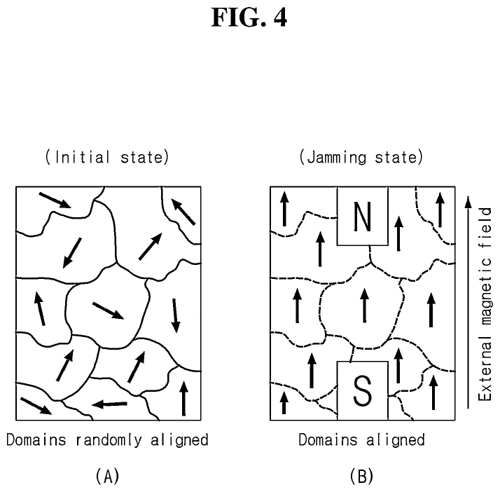

Due to the material properties of soft magnetic particles, there is no magnetic arrangement in the initial state (FIG. 4(A)), but when a magnetic field is applied (jamming state), the magnetic domains within the particle are aligned in the direction of the magnetic field (FIG. 4(B)). Therefore, the interaction ability (grip force) with the external environment during jamming can be adjusted by adjusting the strength of the magnetic force applied to the soft magnetic particles 120.

In one example, the soft magnetic particles 120 include at least two types of particles having different sizes in order to increase the effective permeability by reducing the air gap between the particles as much as possible. In one preferred form, the soft magnetic particles 120 include iron powder with a purity of 99% or more and iron granules with a purity of 99% or more, and the mixing ratio of the powder and granules is preferably 2:3. At this time, the size of the iron granules is 1 to 2 mm. If the iron granule size becomes smaller than 1 mm, the proportion of large particles with high effective permeability is reduced, so the effective permeability cannot be effectively increased, and if it becomes larger than 2 mm, the ability to flexibly adapt to external shapes is reduced during unjamming.

Hereinafter, the sensor 130 will be described.

The sensor 130 includes a first sensor that detects stiffness based on a magnetic force between the soft magnetic particles 110 and the electromagnet 140, and a second sensor that detects an external force applied perpendicularly to a surface of the pouch 110.

Since the jamming mechanism of the present disclosure operates based on a magnetic field, the sensor unit 130 is preferably made of a chemical resin and a conductive film that do not react to the magnetic field for more accurate measurement.

In addition, the sensor 130 is composed of a thin thickness, for example, 1 mm or less, and can adjust the specifications and number of sensing cells as needed.

The first sensor measures the change in stiffness of the soft magnetic particle 120 by measuring the magnetic attraction between the particle and the electromagnet 140, and the second sensor detects the external force applied to the surface of the pouch 110 and detects whether the object to be held is in contact, the strength of the contact, and the contact position.

These first and second sensors may be composed of various known types of sensors, for example, sensors that measure changes in electromagnetic force or pressure that occur when touching an object, and various known types of sensors may be used unless there are special restrictions.

Hereinafter, the electromagnet 140 will be described.

In one preferred form, the electromagnet 140 may be a bipolar electromagnet in the form of a pot core. The core is made of pure iron material and can be annealed to restore its magnetic properties after machining. The coil is made of a heat-resistant coil that can operate at high temperatures (120° C.).

As an example, the electromagnet 140 is cylindrical, but its shape is not particularly limited and the cross-sectional areas of the electromagnet can be polygonal shapes. However, the electromagnet 140 is preferably configured to have a hollow shape to prevent the pouch 110 from being lifted. The hollow 141 provided in the electromagnet 140 not only prevents the pouch from unsettling, but also functions as an air passage for hybrid jamming.

When the electromagnet 140 is configured to include a hollow 141, the jamming mechanism of the present disclosure is configured to further include a mesh filter 131. This mesh filter 131 is attached to the surface of the electromagnet 140, preferably around the hollow 141 of the electromagnet 140, and is located between the electromagnet 140 and the sensor 130. According to this configuration, the air in the pouch 110 generated during the jamming process can be easily discharged to the outside through the hollows 131 and 141, and soft magnetic particles can be prevented from leaking to the outside through the hollows.

The above description is from a mechanical perspective of the magnetic field jamming mechanism 100. In addition to this configuration, electronic components such as microcontrollers and transistors are also required to operate the magnetic field jamming mechanism 100.

The electronic circuit used to operate the magnetic field jamming mechanism 100 described above is composed of elements that can be miniaturized, such as microcontrollers and MOSFETs, and can be used by arranging a plurality of jamming mechanisms in an array depending on the purpose of use. However, even if the number of magnetic field jamming mechanisms increases, controlling multiple magnetic jamming systems is possible with only one controller and single voltage input.

The microcontroller has a switching function to rapidly activate the magnetic field of the electromagnet 140 and a voltage control function to adjust the input voltage using a PWM method to control the magnetic field strength of the electromagnet 140.

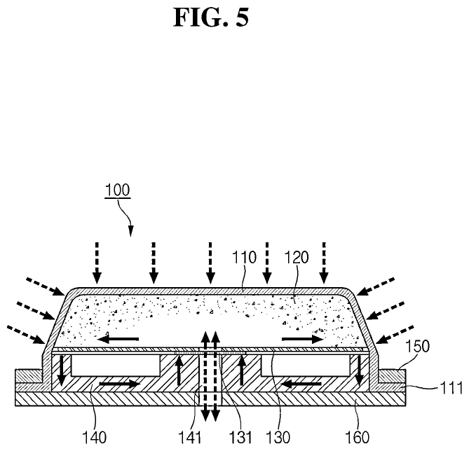

Hereinafter, with reference to FIG. 5, it will be described how the above-described jamming mechanism 100 operates. In FIG. 5, the dotted line represents the air flow, and the solid line represents the path of the magnetic circuit.

Referring to FIG. 5, when a current flows in the coil of the electromagnet 140, a magnetic field flowing along the electromagnet core and soft magnetic particles is generated as shown by the solid line in FIG. 5, and the soft magnetic particles 120 placed on the top of the electromagnet 140 create a magnetic circuit together with the electromagnet.

At this time, magnetic attraction is generated between the soft magnetic particles 120 due to a magnetic field (solid line), and the soft magnetic particles 120 are attracted to each other, thereby generating stiffness (or grip force) of the soft magnetic particles 120, and stiffness occurs in proportion to the intensity of the applied current.

In addition, because the pouch 110 contains soft magnetic particles, since an attractive force (dotted line) also occurs between the soft magnetic particles of the pouch and the soft magnetic particles 120, and the pouch 110 is closely adhered to the shape of the soft magnetic particles 120 inside, the pouch 110 can stiffen the entire structure according to the shape of the external environment, and the stiffness variation can be adjusted with the intensity of the current applied to the electromagnet.

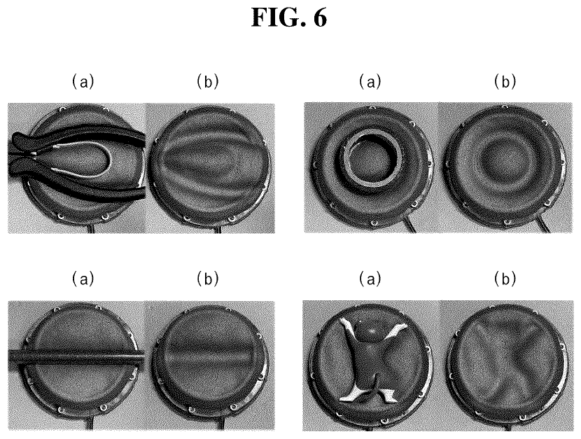

FIG. 6 is pictures taken by a magnetic field jamming mechanism implemented according to an embodiment gripping objects of various shapes. This experiment is to evaluate the shape adaptability of the magnetic field jamming device 100 according to an embodiment to objects of various shapes.

In FIG. 6, (a) illustrates a magnetic field jamming mechanism of one embodiment gripping an object (a), and (b) illustrates a state (b) with only the object removed from the state (a).

As a result of the experiment, it was confirmed that the magnetic field jamming mechanism of one embodiment is capable of gripping a soft object (an object whose shape easily changes) with weak stiffness during initial gripping. In addition, even after increasing the strength of the magnetic field after the initial grip (after adjusting the grip force strongly), the object was able to be gripped stably.

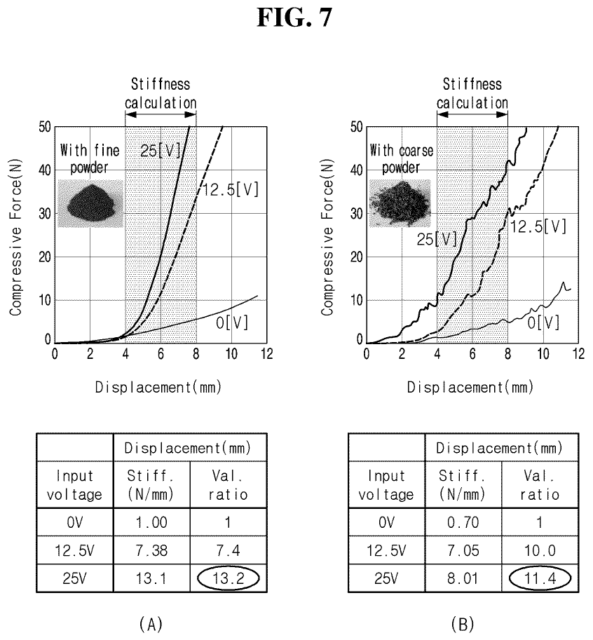

FIG. 7 is a graph illustrating results of measuring changes in stiffness of soft magnetic particles depending on voltage. In FIG. 7, (A) is a result of an experiment with iron powder, and (B) is a result of an experiment with iron granules.

In the experiment, the intensity was measured by changing the input voltage to O V, 12.5 V, and 25 V, respectively, and the relative intensity of 12.5 V and 25 V was measured based on O V. As a result, it can be seen that the relative strength increases as the input voltage increases, and these results show that the stiffness (grip force) of jamming can be adjusted depending on the input voltage.

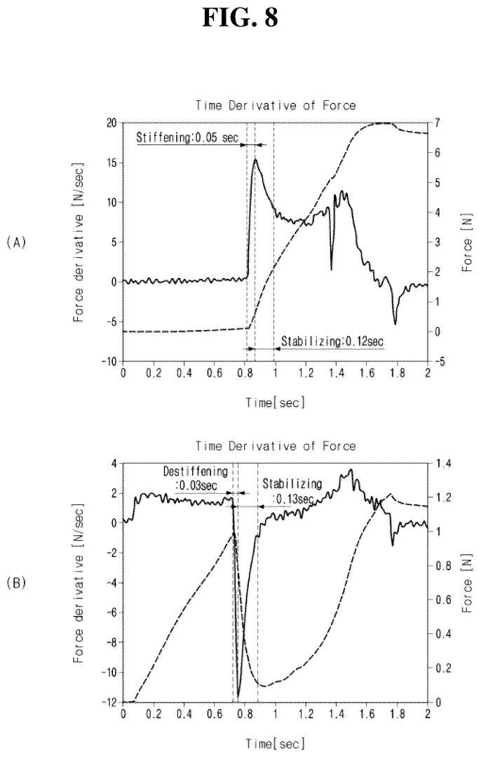

FIG. 8 is a graph illustrating results of measuring response speed of soft magnetic particles according to magnetic field jamming. In FIG. 8, (A) illustrates the reaction speed during jamming, and (B) illustrates the reaction speed during unjamming.

According to the experimental results, when jamming (or gripping), the soft magnetic particles reacted in 0.05 sec and then stabilized in 0.12 sec. When unjamming (or ungripping), the soft magnetic particles reacted in 0.03 sec and stabilized after 0.13 sec.

As a result of the experiment, it was confirmed that the soft magnetic particles responded very quickly and were jammed or unjammed.

In the above, the present disclosure has been examined focusing on its various embodiments. Those skilled in the art of the present disclosure will understand that various embodiments may be implemented in modified forms without departing from the essential characteristics of the present disclosure. Therefore, the disclosed embodiments should be considered from an illustrative rather than a restrictive perspective. The scope of the present disclosure is indicated in the claims rather than the foregoing description, and all differences within the equivalent scope should be construed as being included in the present disclosure.

What is claimed is:

1. A magnetic field jamming mechanism comprising:
a pouch containing a magnetic material;
at least two types of soft magnetic particles of different sizes stored in the pouch;
an electromagnet disposed at an entrance of the pouch and arranging magnetically the soft magnetic particles;
a sensor disposed between the soft magnetic particles and the electromagnet; and
a frame that binds the electromagnet to the entrance of the pouch.

2. The magnetic field jamming mechanism of claim 1, wherein the magnetic material is iron powder with a purity of 99% or more.

3. The magnetic field jamming mechanism of claim 2, wherein the pouch further contains silicone, and
a mixing ratio of the iron powder and the silicon is 3:2 based on weight percent.

4. The magnetic field jamming mechanism of claim 1, wherein a thickness of the pouch is 1 mm or more and 2 mm or less.

5. The magnetic field jamming mechanism of claim 1, wherein the soft magnetic particles contain iron powder with a purity of 99% or more and iron granules with a purity of 99% or more.

6. The magnetic field jamming mechanism of claim 5, wherein a mixing ratio of the iron powder and the iron granules is 3:2 wt %.

7. The magnetic field jamming mechanism of claim 5, wherein a size of the iron granules is 1 to 2 mm.

8. The magnetic field jamming mechanism of claim 1, wherein the electromagnet has a hollow inside.

9. The magnetic field jamming mechanism of claim 8, further comprising:
a mesh filter located between the electromagnet and the sensor and attached to a portion corresponding to the hollow of the electromagnet.

10. The magnetic field jamming mechanism of claim 1, wherein the sensor includes a first sensor that detects stiffness based on a magnetic force between the soft magnetic particles and the electromagnet, and a second sensor that detects an external force applied perpendicularly to a surface of the pouch.
